(19) United States
(12) Patent Application Publication
(10) Pub. No.: US 2011/0209157 A1
(43) Pub. Date: Aug. 25, 2011

(54) RESOURCE ALLOCATION METHOD, PROGRAM, AND RESOURCE ALLOCATION APPARATUS

(75) Inventors: Kiyohiko SUMIDA, Kyoto (JP); Yoshihiro KOGA, Osaka (JP)

(73) Assignee: Panasonic Corporation, Osaka (JP)

(21) Appl. No.: 13/099,597

(22) Filed: May 3, 2011

Related U.S. Application Data
(63) Continuation of application No. PCT/JP2009/005268, filed on Oct. 9, 2009.

(30) Foreign Application Priority Data
Nov. 5, 2008 (JP) 2008-284871

(51) Int. Cl. G06F 9/50

(52) U.S. Cl. 718/104

(57) ABSTRACT

A resource allocation apparatus according to the present invention includes a system information acquisition unit configured to acquire program congestion pattern information indicating a group of programs executed concurrently on a system; and a resource allocation pattern determination unit configured to generate a plurality of resource allocation patterns for allocating the resource to a plurality of programs included in the group of programs indicated in the program congestion pattern information, and to calculate the total of amount of processing needed to execute the programs when the resource is allocated to the programs included in the group of programs by the generated resource allocation patterns, then to determine an optimal resource allocation pattern among the generated resource allocation patterns as a resource allocation pattern for the programs included in the group of programs based on the calculated total amount of processing.

### CROSS REFERENCE TO RELATED APPLICATION

This is a continuation application of PCT application No. PCT/JP2009/005268 filed on Oct. 9, 2009, designating the United States of America.

### BACKGROUND OF THE INVENTION

(1) Field of the Invention

The present invention relates to a resource allocation method, program, and a resource allocation apparatus, and particularly, to a resource allocation method, program, and a resource allocation apparatus that determine a resource allocation pattern indicating the allocation amount of resources allocated to a plurality of programs in a system in which the programs are executed with the resource divided between or shared by the programs.

(2) Description of the Related Art

When a program (software) to be executed on a system is developed, an allocation amount of resources such as a memory to the program needs to be optimally determined. Also, manual allocation of resources has almost reached its performance limit due to an increase in the number of processor cores and the number of programs in recent years, thus the allocation process needs to be automated.

As a conventional resource allocation method of determining such an allocation amount of resources, for example, there is known a technology described in Japanese Unexamined Patent Application Publication No. 2004-70862 (hereinafter referred to as Patent Reference 1). In the technology described in Patent Reference 1, a memory access log of a run-time program is generated by simulating the execution of the run-time program. In the technology described in Patent Reference 1, whether or not a plurality of areas used by the program are allocated to a high-speed memory, or a low speed memory is determined by using the generated memory access log.

### SUMMARY OF THE INVENTION

However, the conventional resource allocation method can be used only in the case of a single program as a target of resource allocation, thus there is a problem in that resources cannot be allocated to a plurality of programs on a system capable of multitasking.

Now, it is an object of the present invention to provide a resource allocation method, program, and a resource allocation apparatus that can allocate resources to a plurality of programs in a system where the programs are executed concurrently.

In order to achieve the above object, the resource allocation method according to the present invention is a resource allocation method for determining a resource allocation pattern indicating allocation amounts of a resource to be allocated to a plurality of programs in a system in which the programs are executed with the resource divided between or shared by the programs, the method including: acquiring a total amount of the resource, an allocation unit of the resource, and program congestion pattern information indicating a group of programs executed concurrently in the system; and determining resource allocation by generating a plurality of resource allocation patterns for allocating the resource to programs included in the group of programs indicated in the program congestion pattern information, using the total amount of the resource and the allocation unit, calculating a total of amount of processing needed to execute the programs when the resource is allocated to the programs included in the group of programs by the generated resource allocation patterns, and determining an optimal resource allocation pattern among the generated resource allocation patterns, as a resource allocation pattern for the programs included in the group of programs, based on the calculated total amount of processing.

According to this, the resource allocation method according to the present invention can optimally allocate resources to a plurality of programs in a system where the programs are executed.

Also, in the determining of resource allocation, a resource allocation pattern with the least total amount of processing needed to execute the programs included in the group of programs among the generated resource allocation patterns is determined as a resource allocation pattern for the programs included in the group of programs.

According to this, the resource allocation method according to the present invention can perform optimal allocation of resources with the least amount of processing.

Also, the determining of resource allocation includes: calculating amount of processing needed to execute the programs when the resource is allocated to respective programs included in the group of programs using a plurality of different resource allocation amounts; and generating the resource allocation patterns using the total amount of the resource and the allocation unit, calculating a total amount of processing which is a total of amount of processing needed to execute the respective programs included in the group of programs in the resource allocation pattern by adding the amount of processing calculated in the calculating of amount of processing, the amount of processing corresponding to a combination of programs and the allocation amounts indicated by each resource allocation pattern of the generated resource allocation patterns, and determining a resource allocation pattern with the least calculated total amount of processing as a resource allocation pattern for the programs included in the group of programs.

Also, the programs can be allocated to one of a plurality of processor cores included in the system to be executed, and the determining of resource allocation includes allocating of processor core for determining a processor core allocation pattern which allocates each of the programs included in the group of programs to any of the processor cores using amount of processing needed to execute each program, the amount of processing when resource in an allocation amount indicated by the resource allocation pattern determined in the determining of resource allocation is allocated to the programs, so that total amount of processing needed to execute one or more programs allocated to each processor core of the processor cores is less than or equal to throughput of the processor core.

According to this, in a system where a plurality of programs are allocated to a plurality of processor cores and executed, the resource allocation method according to the present invention can determine the allocation of programs to the processor cores and the allocation of resources.

Also, the program congestion pattern information indicates a plurality of groups of programs including the group of programs; the groups of programs includes a same program; in the determining of resource allocation, the resource allocation pattern is determined for each of the groups of programs; and the allocating of processor core includes: generating a plurality of processor core allocation patterns for allocating each of the programs included in the group of programs to the processor cores for each of the groups of programs; extracting one or more processor core allocation patterns among processor core allocation patterns for the generated group of programs using amount of processing needed to execute each program, the amount of processing when resource in an allocation amount indicated by a resource allocation pattern corresponding to the group of programs is allocated to the programs, the resource allocation pattern being determined in the determining of resource allocation for each of the groups of programs, so that total amount of processing needed to execute a program allocated to each of the processor cores is less than or equal to throughput of the processor core; and determining a processor core allocation pattern in which the same program is allocated to a same processor core among the extracted one or more processor core allocation patterns for each of the groups of programs, as a processor core allocation pattern for allocating the programs included in the groups of programs to any of the processor cores.

According to this, the resource allocation method according to the present invention can allocate the same programs included in a group of a plurality of programs that are executed concurrently to the same processor core.

Also, the resource corresponds to each of the processor cores, and includes a first resource which is used by the corresponding processor core, and a second resource which is shared by the processor cores; in the acquiring, a total amount of the first resource, a total amount of the second resource, an allocation unit of the first resource, an allocation unit of the second resource, and the program congestion pattern information are acquired; the determining of resource allocation includes: determining a first resource allocation that generates a plurality of first resource allocation patterns for allocating the first resource to the programs included in the groups of programs using the total amount of the first resource and the allocation unit of the first resource, and determines the first resource allocation pattern with the least total amount of processing needed to execute the programs included in the groups of programs among the generated first resource allocation patterns as the first resource allocation pattern for the programs included in the groups of programs; and determining a second resource allocation that generates a plurality of second resource allocation patterns for allocating the second resource to the programs included in the groups of programs using the total amount of the second resource and the allocation unit of the second resource, and determines the second resource allocation pattern with the least total amount of processing needed to execute the programs included in the groups of programs among the generated second resource allocation patterns as the second resource allocation pattern for the programs included in the groups of programs.

According to this, in a system having a first resources such as a level 1 cache included in each processor core, and a second resources such as a level 2 cache commonly used by a plurality of processor cores, the resource allocation method according to the present invention can optimally allocate the first and second resources to a plurality of programs.

The present invention can be achieved not only as this type of resource allocation method, but also as a program which causes a computer to execute specific steps included in the resource allocation method, or as a resource allocation apparatus which includes means for performing such specific steps, or as an integrated circuit (LSI) having a part or all of the function of such a resource allocation apparatus. Also, it needless to say that such a program can be distributed via a recording medium such as a CD-ROM, and a transmission medium such as the Internet.

As described above, the present invention can provide a resource allocation method, program, and a resource allocation apparatus that can allocate resources to a plurality of programs in a system where the programs are executed concurrently.

### FURTHER INFORMATION ABOUT TECHNICAL BACKGROUND TO THIS APPLICATION

The disclosure of Japanese Patent Application No. 2008-284871 filed on Nov. 5, 2008 including specification, drawings and claims is incorporated herein by reference in its entirety.

The disclosure of PCT application No. PCT/JP2009/005268 filed on Oct. 9, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram of a resource allocation apparatus according to Embodiment 1 of the present invention;

FIG. 2 is a flowchart showing the flow of a resource allocation method according to Embodiment 1 of the present invention;

FIG. 3 is a flowchart showing the flow of the operation by a processing amount evaluation simulation unit according to Embodiment 1 of the present invention;

FIG. 4 is a diagram showing an exemplary memory access pattern acquired by the processing amount evaluation simulation unit according to Embodiment 1 of the present invention;

FIG. 5 is a flowchart showing the flow of the operation by a resource allocation simulation unit according to Embodiment 1 of the present invention;

FIG. 6A is a table showing the resource allocation amount and the amount of processing of each program, calculated by the resource allocation apparatus according to Embodiment 1 of the present invention;

FIG. 6B is a table showing the resource allocation pattern and the total amount of processing calculated by the resource allocation apparatus according to Embodiment 1 of the present invention;

FIG. 6C is a table showing the resource allocation pattern for a congestion pattern, calculated by the resource allocation apparatus according to Embodiment 1 of the present invention;

FIG. 7 is a block diagram of a resource allocation apparatus according to Embodiment 2 of the present invention;

FIG. 8 is a flowchart showing the flow of a resource allocation method according to Embodiment 2 of the present invention;

FIG. 9 is a flowchart showing the flow of the operation by a resource allocation simulation unit according to Embodiment 2 of the present invention;

FIG. 10 is a table showing the processor core allocation patterns and the total amount of processing calculated by the resource allocation apparatus according to Embodiment 2 of the present invention;

FIG. 11 is a flowchart showing the flow of the operation by a processor core allocation unit according to Embodiment 2 of the present invention;

FIG. 12 is a table showing the congestion pattern, the resource allocation pattern, and the processor core allocation pattern calculated by the resource allocation apparatus according to Embodiment 2 of the present invention;

FIG. 13 is a block diagram of a resource allocation apparatus according to Embodiment 3 of the present invention;

FIG. 14 is a flowchart showing the flow of the operation of a resource allocation method according to Embodiment 3 of the present invention;

FIG. 15 is a flowchart showing the flow of the operation by a resource allocation simulation unit according to Embodiment 3 of the present invention;

FIG. 16 is a table showing a first resource allocation pattern and the total amount of processing calculated by the resource allocation apparatus according to Embodiment 3 of the present invention; and

FIG. 17 is a flowchart showing the flow of the operation by a second resource allocation pattern determination unit according to Embodiment 3 of the present invention.

### DESCRIPTION OF THE PREFERRED EMBODIMENTS

Hereinafter, embodiments of the resource allocation apparatus and the resource allocation method are described with reference to the drawings. Because the components having the same reference symbols in the embodiments operate in a similar manner, repeated description may be omitted.

### Embodiment 1

The resource allocation apparatus and the resource allocation method according to Embodiment 1 of the present invention acquire information of a plurality of programs to be executed on a system, simulate the amount of processing when resources are allocated to the programs using the acquired information of the programs, and determines the resource allocation amount for each program based on the simulation result. Also, in Embodiment 1 of the present invention, an example of the case of cache memory where resources can be used with the resources divided between or shared by a plurality of programs executed by one processor core is described.

First, the configuration of a resource allocation apparatus 1 according to Embodiment 1 of the present invention is described.

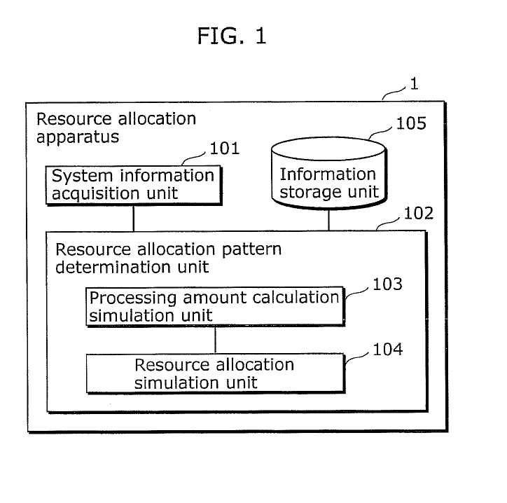

FIG. 1 is a block diagram of the resource allocation apparatus 1 according to Embodiment 1 of the present invention.

For example, the resource allocation apparatus 1 is a software development device for developing software (program) to be executed on a system, and determines the resource allocation pattern indicating the allocation amount of resources allocated to a plurality of programs. The resources herein are, for example, memory resources which are used when a processor executes programs, and particularly a cache memory in a system including a low-speed main memory and a high-speed cache memory. The resource allocation apparatus 1 includes a system information acquisition unit 101, a resource allocation pattern determination unit 102, a processing amount calculation simulation unit 103, and a resource allocation simulation unit 104.

The system information acquisition unit 101 acquires system information inputted from the outside. The system information includes program information indicating a plurality of programs to be executed on a system; resource total amount information indicating the total amount of the resources as a target to be allocated, which are mounted on the system; allocation unit information indicating the allocation unit of the resources; and program congestion pattern information indicating a group of programs executed concurrently on the system.

The resource allocation pattern determination unit 102 optimally determines the allocation amount of resources (hereinafter, a resource allocation amount) for a group of a plurality of programs executed concurrently (hereinafter, a congestion pattern) indicated by the program congestion pattern information.

Specifically, the resource allocation pattern determination unit 102 generates a resource allocation pattern for each congestion pattern using the total amount of the resources and the allocation unit acquired by the system information acquisition unit 101. The resource allocation pattern herein is a pattern of allocating resources to a plurality of programs included in the congestion pattern shown in the program congestion pattern information.

Also, the resource allocation pattern determination unit 102 calculates the total of amount of processing (hereinafter, a total amount of processing) needed to execute a plurality of programs when resources are allocated to the programs included in a congestion pattern by the generated plurality of resource allocation patterns.

Also, based on the total of the calculated amount of processing, the resource allocation pattern determination unit 102 determines the optimal resource allocation pattern among the generated plurality of resource allocation patterns, as the resource allocation pattern for the programs included in the congestion pattern. Specifically, the resource allocation pattern determination unit 102 determines the resource allocation pattern in which the calculated total amount of processing is smaller than the target amount of processing requested to the system and is the least, as the resource allocation pattern for the programs included in the congestion pattern. The amount of processing is the quantity of processing needed for the processor core to execute the programs, and specifically, the number of clocks per unit time used by the processor core to execute the programs.

Also, the resource allocation pattern determination unit 102 determines the resource allocation pattern in which the total amount of processing is the least among the generated resource allocation patterns, as the resource allocation pattern for the congestion pattern.

The resource allocation pattern determination unit 102 includes a processing amount calculation simulation unit 103 and a resource allocation simulation unit 104.

Throughput calculation simulation unit 103 calculates the amount of processing needed to execute the programs when the resources are allocated to respective programs included in a plurality of congestion patterns using a plurality of different resource allocation amounts.

The resource allocation simulation unit 104 generates a plurality of resource allocation patterns for the congestion patterns using the total amount and the allocation unit of the resources. Also, for each of the resource allocation patterns generated for the congestion patterns, the resource allocation simulation unit 104 calculates the total amount of processing in the resource allocation pattern. Specifically, the resource allocation simulation unit 104 calculates the total amount of processing by adding the amount of processing calculated by the processing amount calculation simulation unit 103, the amount of processing corresponding to combinations of the programs and the allocation amounts indicated by the resource allocation pattern. Also, the resource allocation simulation unit 104 determines the resource allocation pattern with the least calculated total amount of processing as the resource allocation pattern for the programs included in the group of programs.

An information storage unit 105 stores the data during processing calculated by the resource allocation pattern determination unit 102. Specifically, the information storage unit 105 stores data including the amount of processing per program calculated by the processing amount calculation simulation unit 103, and the total amount of processing per resource allocation pattern calculated by the resource allocation simulation unit 104.

The system information acquisition unit 101, the processing amount calculation simulation unit 103, and the resource allocation simulation unit 104 are normally achieved by e.g., an MPU (Micro Processing Unit) and a memory. Also, the functions of the system information acquisition unit 101, the processing amount calculation simulation unit 103, and the resource allocation simulation unit 104 are normally achieved by the MPU executing software (program). Also, the software is recorded in a recording medium (memory) such as a ROM. A part or all of the functions of the system information acquisition unit 101, the processing amount calculation simulation unit 103, and the resource allocation simulation unit 104 may be achieved by hardware (dedicated circuit).

Also, the information storage unit 105 is achieved by a memory such as a RAM.

Next, a resource allocation method performed by the resource allocation apparatus 1 is described.

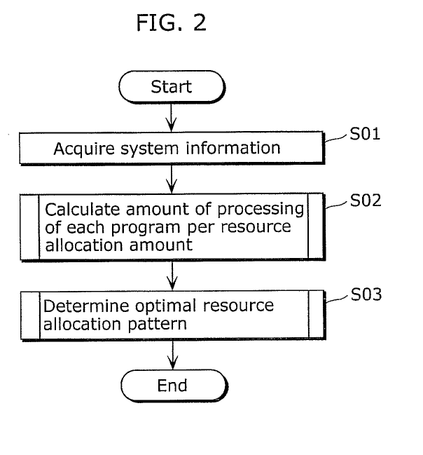

FIG. 2 is a flowchart schematically showing the flow of the resource allocation method performed by the resource allocation apparatus 1.

### (Step S01)

In step S01, the system information acquisition unit 101 first acquires the system information inputted from the outside, which is to be used by the resource allocation method. The system information acquired by the system information acquisition unit 101 includes program information indicating a plurality of programs to be executed on a system; resource total amount information indicating the total amount of the resources as a target to be allocated, which are mounted on the system; allocation unit information indicating the allocation unit of the resources; and program congestion pattern information indicating a group of programs executed concurrently on the system.

### (Step S02)

In step S02, the processing amount calculation simulation unit 103 calculates the amount of processing of each program when different resource allocation amounts are allocated to respective programs.

### (Step S03)

In step S03, the resource allocation simulation unit 104 determines the resource allocation pattern for a plurality of programs so that the total amount of processing of the programs becomes the minimum for each congestion pattern.

Next, detailed operation in step S02 is described.

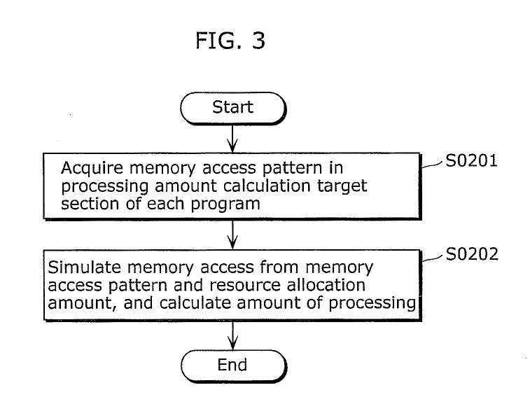

FIG. 3 is a flowchart showing the flow of the operation in step S02.

### (Step S0201)

In step S0201, the processing amount calculation simulation unit 103 prepares for the amount of processing calculation of each program indicated in the program information acquired by the system information acquisition unit 101. That is to say, the processing amount calculation simulation unit 103 acquires the memory access pattern to the main memory of the program by executing programs in the amount of processing calculation target section included in each program on a simulator.

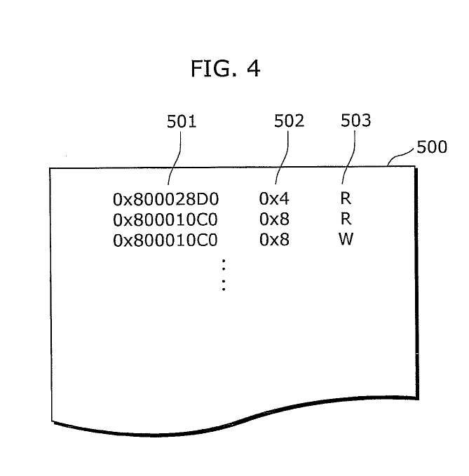

FIG. 4 is a diagram showing an exemplary memory access pattern 500 acquired by the processing amount calculation simulation unit 103. As shown in FIG. 4, for each access, the memory access pattern 500 includes an address 501 accessed by the program, the size 502 of the accessed data, and information 503 indicating whether the access is a read access or a write access.

### (Step S0202)

In step S0202, using the memory access pattern 500 of each program acquired in step S0201, the processing amount calculation simulation unit 103 calculates the amount of processing of the program for each allocation amount of resources to the program. Specifically, the processing amount calculation simulation unit 103 simulates hit and miss to the cache memory in case where the main memory is accessed by the memory access pattern 500, then calculates the amount of processing based on the simulation result. That is to say, the processing amount calculation simulation unit 103 performs a simulation so that the access latency at the time of a miss is greater than that at the time of a hit. In other words, the processing amount calculation simulation unit 103 performs a simulation so that the execution time (amount of processing) at the time of a miss is greater than that (amount of processing) at the time of a hit.

By the above operation, the processing amount calculation simulation unit 103 can calculate the amount of processing of each program per resource allocation amount.

Next, detailed operation in step S03 is described.

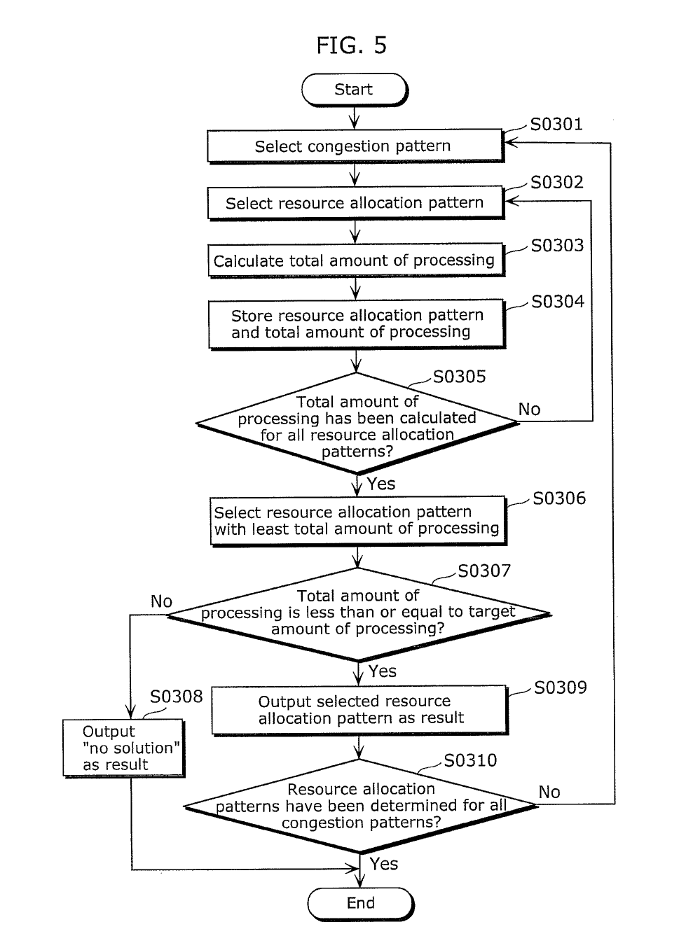

FIG. 5 is a flowchart showing the flow of detailed operation in step S03.

### (Step S0301)

In step S0301, the resource allocation simulation unit 104 selects one congestion pattern from a plurality of congestion patterns indicated in the program congestion pattern information acquired by the system information acquisition unit 101. Also, the process from step S0301 to the later-described step S0310 form a loop, and all the congestion patterns are sequentially selected in step S0301.

### (Step S0302)

In step S0302, the resource allocation simulation unit 104 generates a plurality of resource allocation patterns for the congestion pattern selected in step S0301. Also, the resource allocation simulation unit 104 selects one resource allocation pattern among the generated resource allocation patterns. The number of the resource allocation patterns generated by the resource allocation simulation unit 104 is determined by the number of the programs included in the congestion pattern, the total amount of the resources, and the allocation unit of the resources. Also, the process from step S0302 to a later-described step S0305 form a loop, and all the resource allocation patterns are sequentially selected in step S0302.

### (Step S0303)

In step S0303, the resource allocation simulation unit 104 calculates the total amount of processing of the programs included in the congestion pattern selected in step S0301 according to the resource allocation pattern selected in step S0302. Specifically, the resource allocation simulation unit 104 totals the amount of processing calculated in step S02, which corresponds to the resource allocation amount allocated to each program in the resource allocation pattern.

### (Step S0304)

In step S0304, the resource allocation simulation unit 104 associates the total amount of processing calculated in step S0303 with the congestion pattern selected in step S0301 and the resource allocation pattern selected in step S0302, then stores the total amount of processing and the patterns in the information storage unit 105.

### (Step S0305)

In step S0305, the resource allocation simulation unit 104 determines whether or not all the resource allocation patterns to be selected in step S0302 have been selected. In the case where there exists an unselected resource allocation pattern, the resource allocation simulation unit 104 selects a new resource allocation pattern in step S0302, then later performs step S0303 and the subsequent process, otherwise in the case where all the resource allocation patterns have been selected, the process in step S0306 is performed next.

### (Step S0306)

In step S0306, the resource allocation simulation unit 104 selects a resource allocation pattern with the least total amount of processing from the resource allocation patterns for the congestion pattern currently selected and stored in the information storage unit 105.

### (Step S0307)

In step S0307, the resource allocation simulation unit 104 determines whether or not the total amount of processing of the resource allocation pattern selected in step S0306 is less than or equal to a target amount of processing. The target amount of processing herein is the value of the processor core frequency, or the value plus a margin. Also, when the amount of processing exceeds the target value, the resource allocation simulation unit 104 next performs the process in step S0308, while when the amount of processing does not exceed the target value, the resource allocation simulation unit 104 next performs the process in step S0309.

### (Step S0308)

In step S0308, because the resource allocation simulation unit 104 has not found a resource allocation pattern which satisfies the target amount of processing up to step S0307, the resource allocation simulation unit 104 outputs “no solution” to the outside and terminates the allocation process.

### (Step S0309)

In step S0309, the resource allocation simulation unit 104 outputs the resource allocation pattern selected in step S0306 to the outside as the resource allocation pattern for the currently selected congestion pattern.

### (Step S0310)

In step S0310, the resource allocation simulation unit 104 determines whether or not all the congestion patterns included in the program congestion pattern information selected in step S0301 have been selected in step S0301. In the case where there exists an unselected congestion pattern, the resource allocation simulation unit 104 then selects a new congestion pattern in step S0301, and performs step S0302 and subsequent process for the selected congestion pattern. Otherwise, in the case where all the congestion patterns have been selected, the resource allocation simulation unit 104 terminates the allocation process.

By the above process, a resource allocation pattern is determined for all the congestion patterns included in the program congestion pattern information.

Hereinafter, an exemplary specific operation by the resource allocation method according to Embodiment 1 of the present invention is described.

In step S01, the system information acquisition unit 101 acquires the system information inputted from the outside, which is to be used by the resource allocation method. The program information included in the system information indicates that 5 programs: prog A, prog B, prog C, prog D, and prog E are executed on the system; the resource total amount information indicates that the resources as a target to be allocated is 16 KB cache memory; the allocation unit information indicates that the allocation unit is 4 KB; and the program congestion pattern information indicates 3 patterns, (prog A, prog B, prog C), (prog A, prog B, prog D), and (prog A, prog B, prog E) as the congestion patterns of program.

In step S02, the processing amount calculation simulation unit 103 calculates the amount of processing of each of 5 programs (prog A, prog B, prog C, prog D, and prog E) indicated in the program information by sequentially changing the allocation amount for the program to the cache memory.

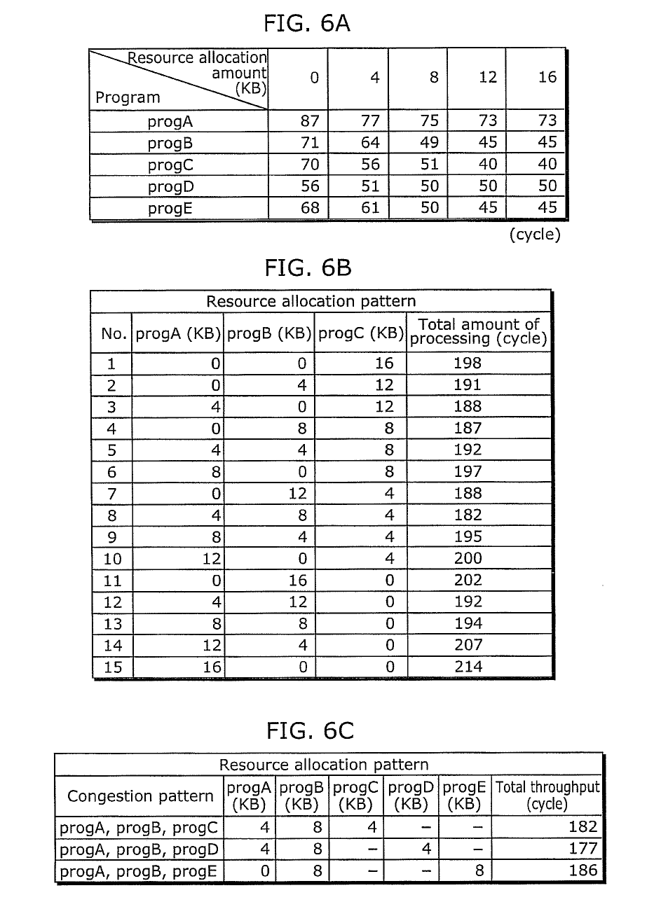

FIG. 6A is an exemplary table showing the amount of processing of each program calculated by the processing amount calculation simulation unit 103. As shown in FIG. 6A, the processing amount calculation simulation unit 103 calculates the amount of processing (required number of clocks per unit time) for each plurality of allocation amounts for each of the prog A, prog B, prog C, prog D, and prog E. Specifically, the allocation amounts are the amounts incremented by an allocation unit of 4 KB (0 KB, 4 KB, 8 KB, 12 KB, and 16 KB) from the case where no capacity of cache memory is allocated (0 KB) to the case where all the capacity of cache memory is allocated (16 KB). As shown in FIG. 6A, generally, as the allocation amount is increased, the amount of processing of the program is decreased.

In step S03, the resource allocation simulation unit 104 calculates the allocation amount for each program to the cache.

Specifically, in step S0301, the resource allocation simulation unit 104 first selects the congestion pattern of program, (prog A, prog B, prog C).

Next, in step S0302, the resource allocation simulation unit 104 generates a plurality of resource allocation patterns for the congestion pattern (prog A, prog B, prog C), selects one of the generated resource allocation patterns.

FIG. 6B is exemplary table showing the resource allocation pattern for the congestion pattern (prog A, prog B, prog C), and the total amount of processing in the case where the resource allocation pattern is used.

As shown in FIG. 6B, the resource allocation simulation unit 104 generates 15 resource allocation patterns (No.1 to No.15) for the congestion pattern (prog A, prog B, prog C). Specifically, the resource allocation simulation unit 104 generates all the resource allocation patterns by allocating 16 KB of the total amount of resources to 3 programs (prog A, prog B, prog C) with the allocation amount for each program being incremented by the allocation unit of 4 KB.

In this example, the resource allocation simulation unit 104 selects No.1 resource allocation pattern (0 KB, 0 KB, 16 KB) in step S0302.

In step S0303, the resource allocation simulation unit 104 acquires the amount of processing of each program in the allocation amount indicated by the resource allocation pattern (0 KB, 0 KB, 16 KB) from the table shown in FIG. 6A, and calculates the total of the acquired amount of processing. Specifically, the amount of processing of prog A at the time of allocation amount of 0 KB is “87”, the amount of processing of prog B at the time of allocation amount of 0 KB is “71”, the amount of processing of prog C at the time of allocation amount of 16 KB is “40”, thus the total amount of processing of the No.1 resource allocation pattern is “198.”

In step S0304, the resource allocation simulation unit 104 associates the total amount of processing calculated in step S0303 with the resource allocation pattern, and stores the total amount of processing and the pattern in the information storage unit 105.

Also, the resource allocation simulation unit 104 performs the process in steps S0302 to S0304 for all the resource allocation patterns (No.1 to No.15). As a result, the data corresponding to the table shown in FIG. 6B is stored in the information storage unit 105.

Next, in step S0306, the resource allocation simulation unit 104 selects the resource allocation pattern with the least total amount of processing from the resource allocation patterns (No.1 to No.15) included in the table shown in FIG. 6B. In this case, because the total amount of processing of No.8 resource allocation pattern is the least, the resource allocation simulation unit 104 selects the No.8 resource allocation pattern.

Next, in step S0307, the resource allocation simulation unit 104 determines whether or not the total amount of processing of “182” for the No.8 resource allocation pattern selected in step S0306 is less than or equal to the target amount of processing. For example, in the case where the target amount of processing is “200”, the resource allocation simulation unit 104 determines with the total amount of processing is less than or equal to the target amount of processing.

In step S0309, the resource allocation simulation unit 104 outputs the No.8 resource allocation pattern selected in step S0306 as the resource allocation pattern for the congestion pattern (prog A, prog B, prog C).

Also, the resource allocation simulation unit 104 outputs the resource allocation patterns for all the congestion patterns by performing the process in steps S0301 to S0309 for all the congestion patterns ((prog A, prog B, prog C), (prog A, prog B, prog D), and (prog A, prog B, prog E)).

FIG. 6C is a table showing the resource allocation patterns and total amount of processing for all the congestion patterns outputted by the resource allocation apparatus 1. As shown in FIG. 6C, the resource allocation simulation unit 104 can determine the resource allocation patterns for all the congestion patterns.

As described above, according to the resource allocation apparatus 1 and the resource allocation method by Embodiment 1 of the present invention, the optimal resource allocation which guarantees operational performance of the system can be made by allocating resources such as a cache memory based on the amount of processing per resource allocation amount to the target system where a plurality of programs are executed concurrently.

### Embodiment 2

In Embodiment 2 of the present invention, the resource allocation in a system having a plurality of processor cores is described. The resource allocation apparatus 2 according to Embodiment 2 of the present invention further performs process of allocating each program to one of the processor cores in addition to the process by the resource allocation apparatus 1 according to Embodiment 1.

Also, in Embodiment 2, the resource is the cache memory, which is shared by the plurality of processor cores. Also, a plurality of programs which are executed on a system can be allocated to one of the processor cores to be executed. Also, the cache memory is used with the memory divided between or shared by a plurality of programs.

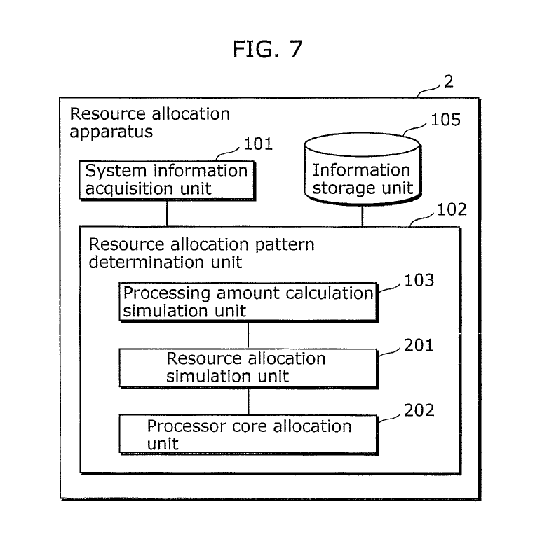

FIG. 7 is a block diagram of the resource allocation apparatus 2 according to Embodiment 2 of the present invention.

The resource allocation apparatus 2 shown in FIG. 7 includes the system information acquisition unit 101, the resource allocation pattern determination unit 102, the processing amount calculation simulation unit 103, a resource allocation simulation unit 201, and a processor core allocation unit 202.

In addition to the configuration of the resource allocation apparatus 1 according to Embodiment 1, the resource allocation apparatus 2 further includes the processor core allocation unit 202. Also, the resource allocation apparatus 2 has a different configuration of the resource allocation simulation unit 201 compared with the resource allocation apparatus 1 according to Embodiment 1.

In FIG. 7, similar components as shown in FIG. 1 are labeled with the same reference symbols, and repeated description is omitted.

For each congestion pattern, the resource allocation simulation unit 201 calculates a resource allocation pattern and the total amount of processing in the resource allocation pattern. Also, for each congestion pattern, the resource allocation simulation unit 201 extracts combinations of a resource allocation pattern and a processor core allocation pattern in which the programs included in the congestion pattern can be allocated to a plurality of processor cores to be executed. The processor core allocation pattern is information indicating in which processor core each program is to be executed, and its allocation does not depend on the congestion pattern of program.

The processor core allocation unit 202 determines the optimal resource allocation pattern and processor core allocation pattern from the combinations of resource allocation patterns and processor core allocation patterns for a plurality of congestion patterns, which have been extracted by the resource allocation simulation unit 201.

The resource allocation simulation unit 201 and the processor core allocation unit 202 are normally achieved by e.g., an MPU, and a memory. The functions of the resource allocation simulation unit 201 and the processor core allocation unit 202 are normally achieved by the MPU executing software (program). Also, the software is recorded on a recording medium (memory) such as a ROM. However, a part or all of the functions of the resource allocation simulation unit 201, and the processor core allocation unit 202 may be achieved by hardware (dedicated circuit).

Next, the operation of the resource allocation method performed by the resource allocation apparatus 2 is described.

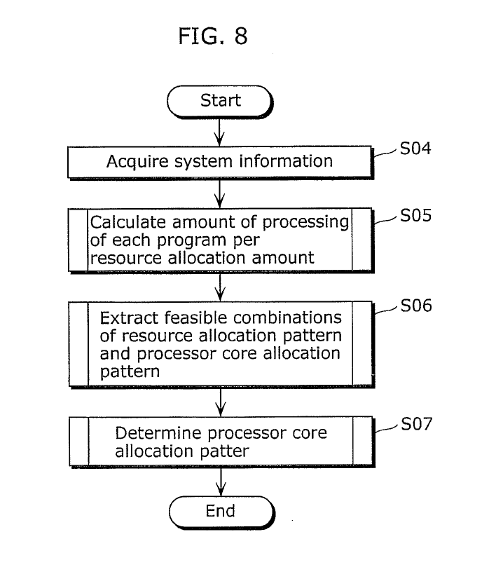

FIG. 8 is a flowchart schematically showing the flow of the resource allocation method performed by the resource allocation apparatus 2. The process in steps S04 and S05 shown in FIG. 8 is similar to that in steps S01 and S02 shown in FIG. 2, thus detailed description is omitted.

### (Step S04)

In step S04, the system information acquisition unit 101 first acquires the system information inputted from the outside, which is to be used by the resource allocation method. The system information acquired by the system information acquisition unit 101 includes program information indicating a plurality of programs to be executed on a system; resource total amount information indicating the total amount of the resources as a target to be allocated, which are mounted on the system; allocation unit information indicating the allocation unit of the resources; and program congestion pattern information indicating a group of programs executed concurrently on the system.

### (Step S05)

In step S05, the processing amount calculation simulation unit 103 calculates the amount of processing of each program when different resource allocation amounts are allocated to respective programs.

### (Step S06)

In step S06, the resource allocation simulation unit 201 calculates the resource allocation amount to each program for each congestion pattern. Also, for each congestion pattern, the resource allocation simulation unit 201 extracts combinations of a resource allocation pattern and a processor core allocation pattern in which the programs included in the congestion pattern can be allocated to a plurality of processor cores to be executed.

Specifically, by using the amount of processing of each program when the resources in the amount of allocation indicated by a resource allocation pattern having smaller total amount of processing than the target amount of processing are allocated to a plurality of programs, the resource allocation simulation unit 201 extracts the combinations of a resource allocation pattern and a processor core allocation pattern such that for each of the processor cores, the total amount of processing needed to execute one or more programs allocated to the processor core is less than the throughput of the processor core.

### (Step S07)

In step S07, the processor core allocation unit 202 determines the optimal resource allocation pattern and processor core allocation pattern from the combinations of resource allocation patterns and processor core allocation patterns for a plurality of congestion patterns, which have been extracted by the resource allocation simulation unit 201.

Next, detailed operation in step S06 is described.

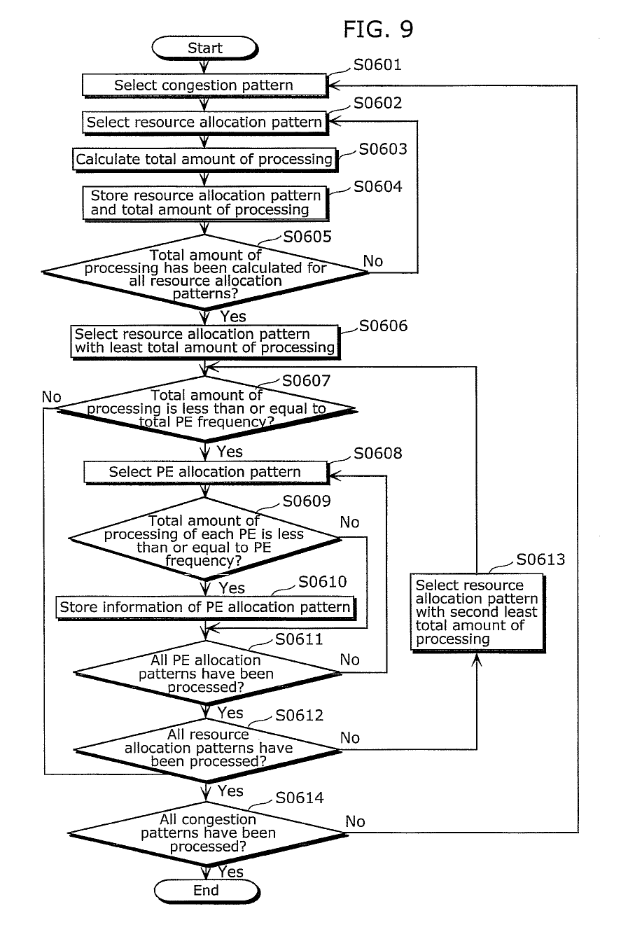

FIG. 9 is a flowchart showing the flow of detailed operation in step S06. The process in steps S0601 to S0606 shown in FIG. 9 is similar to that in steps S0301 to S0306 shown in FIG. 5.

### (Step S0601)

In step S0601, the resource allocation simulation unit 201 selects one congestion pattern from a plurality of congestion patterns indicated in the program congestion pattern information acquired by the system information acquisition unit 101. Also, the process from step S0601 to a later-described step S0614 form a loop, and all the resource allocation patterns are sequentially selected in step S0601.

### (Step S0602)

In step S0602, the resource allocation simulation unit 201 generates a plurality of resource allocation patterns for the congestion pattern selected in step S0601. Also, the resource allocation simulation unit 201 selects one resource allocation pattern among the generated resource allocation patterns. The number of the resource allocation patterns generated by the resource allocation simulation unit 201 is determined by the number of the programs included in the congestion pattern, the total amount of the resources, and the allocation unit of the resources. Also, the process from step S0602 to a later-described step S0605 form a loop, and all the resource allocation patterns are sequentially selected in step S0602.

### (Step S0603)

In step S0603, the resource allocation simulation unit 201 calculates the total amount of processing of the programs included in the congestion pattern selected in step S0601 according to the resource allocation pattern selected in step S0602. Specifically, the resource allocation simulation unit 201 totals the amount of processing calculated in step S05, which corresponds the resource allocation amount allocated to each program in the resource allocation pattern.

### (Step S0604)

In step S0604, the resource allocation simulation unit 201 associates the total amount of processing calculated in step S0603 with the congestion pattern selected in step S0601 and the resource allocation pattern selected in step S0602, then stores the total amount of processing and the patterns in the information storage unit 105.

### (Step S0605)

In step S0605, the resource allocation simulation unit 201 determines whether or not all the resource allocation patterns to be selected in step S0602 have been selected. In the case where there exists an unselected resource allocation pattern, the resource allocation simulation unit 201 selects a new resource allocation pattern in step S0602, then later performs step S0603 and the subsequent process, otherwise in the case where all the resource allocation patterns have been selected, the resource allocation simulation unit 201 next performs the process in step S0606.

### (Step S0606)

In step S0606, the resource allocation simulation unit 201 selects a resource allocation pattern with the least total amount of processing from the resource allocation patterns for the congestion pattern currently selected and stored in the information storage unit 105.

### (Step S0607)

In step S0607, the resource allocation simulation unit 201 determines whether or not the total amount of processing of the resource allocation pattern selected in step S0606 is less than the total of the throughput (operating frequencies) of a plurality of processor cores (PE) (i.e., whether or not a plurality of congested programs can be allocated to the processor cores according to the resource allocation pattern to be executed). In the case where the total amount of processing is less than the total frequency of the processor cores, the resource allocation simulation unit 201 next performs the process in step S0608, otherwise in the case where the total amount of processing is greater than the total frequency of the processor cores, the resource allocation simulation unit 201 next performs the process in step S0614.

### (Step S0608)

In step S0608, the resource allocation simulation unit 201 generates a plurality of processor core allocation patterns for allocating the programs which are executed in the congestion pattern selected in step S0601 to the processor cores, and selects one of the generated processor core allocation patterns. The number of the processor core allocation patterns is determined by the number of the processor cores, and the number of the programs included in the congestion pattern. Specifically, the number of the processor core allocation patterns is N̂ M where N is the number of the processor cores, and M is the number of the programs. Also, the process from step S0608 to a later-described step S0611 form a loop, and all the resource allocation patterns are sequentially selected in step S0608.

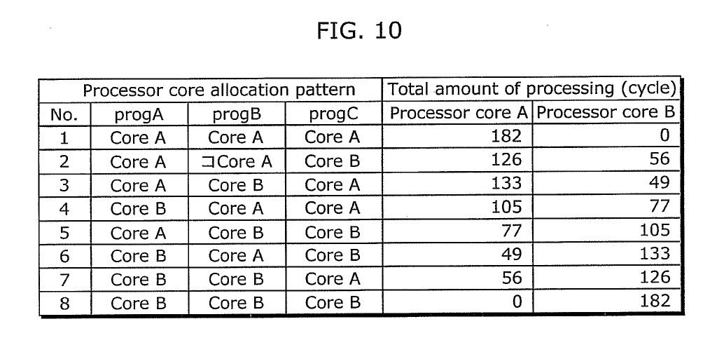

FIG. 10 is a table showing the processor core allocation patterns and the total amount of processing. For example, in the case where the number of processor cores is 2 (processor core A and processor core B), and the group of (prog A, prog B, prog C) is selected as a congestion pattern, the resource allocation simulation unit 201 generates 8 processor core allocation patterns as shown in FIG. 10.

### (Step S0609)

In step S0609, the resource allocation simulation unit 201 calculates the total amount of processing of the programs allocated to each processor core when the resource allocation pattern selected in step S0606 (or later-described step S0613) is applied to the processor core allocation pattern selected in step S0608.

Also, the resource allocation simulation unit 201 determines whether or not the calculated total amount of processing of the programs allocated to each processor core is less than or equal to the throughput of the processor core (less than or equal to the operating frequency). In the case where the total amount of processing of the programs allocated to each processor core is less than or equal to the operating frequency of the processor core, the resource allocation simulation unit 201 next performs the process in step S0610, otherwise in the case where at least one of the total amount of processing of the programs in each processor core is greater than the operating frequency of the processor core, the resource allocation simulation unit 201 next performs the process in step S0611.

For example, in the case where the No.8 resource allocation pattern shown in FIG. 6B is selected in step S0606, the resource allocation simulation unit 201 calculates the total amount of processing of each processor core (the processor core A and the processor core B) shown in FIG. 10. Also, in the case where the operating frequencies of the processor core A and the processor core B are both 150 cycles, for No.1 processor core allocation pattern shown in FIG. 10, the resource allocation simulation unit 201 determines that the total amount of processing of each processor core is greater than the operating frequency of the processor core because the total amount of processing of the processor core A is 182 cycles. Also, for No.2 processor core allocation pattern shown in FIG. 10, the resource allocation simulation unit 201 determines that the total amount of processing of each processor core is less than or equal to the operating frequency of the processor core because the total amount of processing of the processor core A is 126 cycles and the total amount of processing of the processor core B is 56 cycles.

### (Step S0610)

In step S0610, the resource allocation simulation unit 201 associates the currently selected processor core allocation pattern with the resource allocation pattern and the congestion pattern, then stores the patterns in the information storage unit 105.

### (Step S0611)

In step S0611, the resource allocation simulation unit 201 determines whether or not all the processor core allocation patterns have been already selected in step S0608. In the case where there exists an unselected processor core allocation pattern, the resource allocation simulation unit 201 then selects the unselected processor core allocation pattern in step S0608, and performs step S0609 and the subsequent process. In the case where all the processor core allocation patterns have been selected, the resource allocation simulation unit 201 performs the process in step S0612.

### (Step S0612)

In step S0612, the resource allocation simulation unit 201 determines whether or not all the resource allocation patterns have been already selected in step S0606 or in a later-described step S0613. In the case where there exists an unselected resource allocation pattern, the resource allocation simulation unit 201 next performs the process in step S0613, otherwise in the case where all the resource allocation patterns have been selected, the resource allocation simulation unit 201 next performs the process in step S0614.

### (Step S0613)

In step S0613, the resource allocation simulation unit 201 selects a resource allocation pattern with the second least total amount of processing next to the currently selected resource allocation pattern from the resource allocation patterns for the congestion pattern currently selected, then performs step S0607 and the subsequent process.

### (Step S0614)

In step S0614, the resource allocation simulation unit 201 determines whether or not all the congestion patterns have been already selected in step S0601. In the case where there exists an unselected congestion pattern, the resource allocation simulation unit 201 selects a new congestion pattern in step S0601, and performs step S0602 and the subsequent process for the newly selected congestion pattern. Also, in the case where all the congestion patterns have been selected, the resource allocation simulation unit 201 terminates the process in step S06.

By the above process, the resource allocation simulation unit 201 can extract combinations of a resource allocation pattern and a processor core allocation pattern in which the programs included in each congestion pattern can be allocated to the processor cores to be executed, and can store the information of the extracted combinations in the information storage unit 105.

Specifically, the resource allocation simulation unit 201 can extract combinations of a resource allocation pattern and a processor core allocation pattern in which the total amount of processing of all the programs included in the congestion pattern is less than the total throughput of all the processor cores, and the total amount of processing of the programs allocated to each processor core is less than the throughput of the processor core.

Although in the above description, the process in steps S0608 to S0610 are performed for all the resource allocation patterns in which the total amount of processing is less than the total of the operating frequencies of the processor core, the process in steps S0608 to S0610 may be performed only for the resource allocation pattern with the least total amount of processing. That is to say, the resource allocation simulation unit 201 may extract the combination of the resource allocation pattern and the processor core allocation pattern with the least total amount of processing.

Next, detailed operation in step S07 is described.

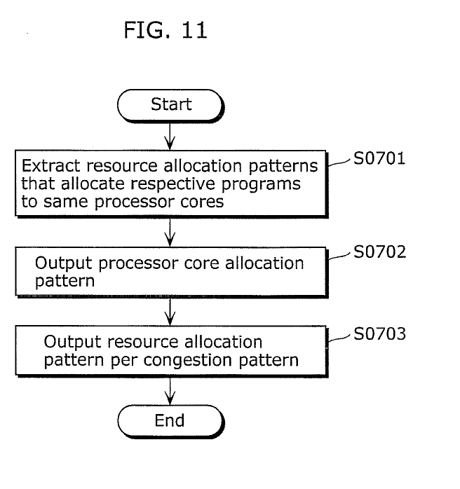

FIG. 11 is a flowchart showing the flow of the process in step S07.

### (Step S0701)

In step S0701, in order to determine the allocation of each program to the processor cores, the processor core allocation unit 202 extracts those combinations of a processor core allocation pattern and a resource allocation pattern that allocate respective program to the same processor cores in a plurality of congestion patterns, from the combinations of a processor core allocation pattern and a resource allocation pattern stored in step S0610 for each congestion pattern.

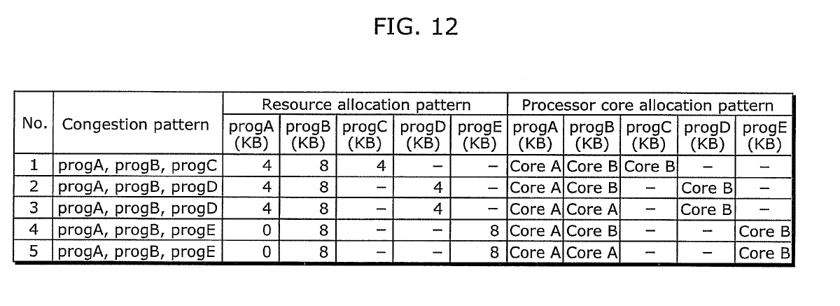

FIG. 12 is a table showing exemplary combinations of the congestion patterns, the resource allocation patterns, and the processor core allocation patterns stored in the information storage unit 105. For simplification of the description herein, combinations of one resource allocation pattern, and the processor core allocation pattern corresponding to the allocation pattern are stored in one congestion pattern, however, combinations of a plurality of resource allocation patterns, and the processor core allocation patterns corresponding to the resource allocation patterns may be stored in one congestion pattern.

For example, in the case of the example shown in FIG. 12, from 5 sets (No.1 to No.5), the processor core allocation unit 202 extracts those sets that include processor core allocation patterns in which the programs contained in all of 3 congestion patterns (prog A and prog B) are allocated to the same processor. Specifically, the sets (No.1, 2, 4) including the processor core allocation patterns in which program A is allocated to core A, and program B is allocated to core B exist as 3 congestion patterns, thus the processor core allocation unit 202 extracts the sets (No.1, 2, 4).

### (Step S0702)

In step S0702, the processor core allocation unit 202 outputs the processor core allocation patterns included in the sets (No.1, 2, 4) extracted in step S0701 as the allocation results of the processor cores. Specifically in the example shown in FIG. 12, the processor core allocation unit 202 outputs the processor core allocation patterns in which prog A is allocated to the processor core A, and prog B to prog E are allocated to the processor core B.

### (Step S0703)

In step S0703, the processor core allocation unit 202 outputs the resource allocation pattern for each congestion pattern included in the sets (No.1, 2, 4) extracted in step S0701 as a resource allocation result. Specifically, the processor core allocation unit 202 outputs the resource allocation result similar to that in FIG. 6C.

In the case where a plurality of sets have been extracted for each congestion pattern in step S0701, the processor core allocation unit 202 may output the processor core allocation patterns and the resource allocation patterns included in all the extracted sets as an allocation result, or may output the processor core allocation pattern and the resource allocation pattern included in any one of the extracted sets as an allocation result. For example, the processor core allocation unit 202 may output the resource allocation pattern with the least total amount of processing among the resource allocation patterns included in the sets, and the corresponding processor core allocation pattern.

As described above, the resource allocation apparatus 2 and the resource allocation method according to Embodiment 2 of the present invention can determine the optimal processor core allocation pattern and resource allocation pattern which can guarantee operational performance for the target system with multiple processor cores.

### Embodiment 3

In Embodiment 3 of the present invention, the resources correspond to the respective processor cores, and includes the cache memory exclusively used by the corresponding processor core (primary cache, or a level 1 cache), and the cache memory shared among multiple processor cores (secondary cache, or level 2 cache).

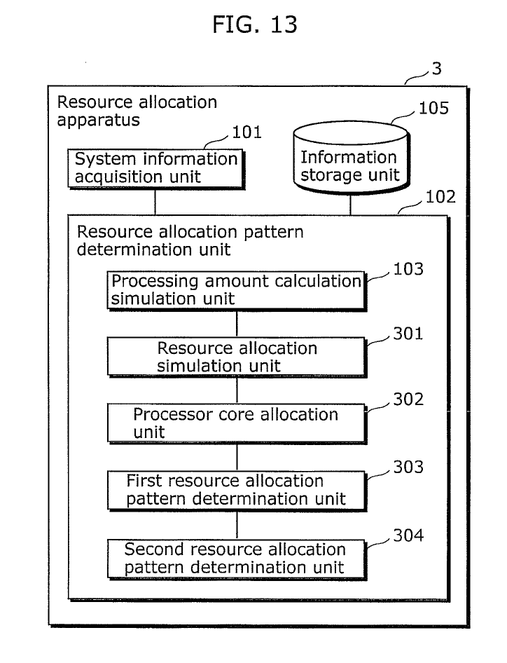

FIG. 13 is a block diagram of a resource allocation apparatus 3 according to Embodiment 3 of the present invention.

The resource allocation apparatus 3 shown in FIG. 13 includes the system information acquisition unit 101, the resource allocation pattern determination unit 102, the processing amount calculation simulation unit 103, a resource allocation simulation unit 301, a processor core allocation unit 302, a first resource allocation pattern determination unit 303, and a second resource allocation pattern determination unit 304.

In addition to the configuration of the resource allocation apparatus 1 according to Embodiment 1, the resource allocation apparatus 3 further includes the processor core allocation unit 302, the first resource allocation pattern determination unit 303, and the second resource allocation pattern determination unit 304. Also, the resource allocation apparatus 3 has a different configuration of the resource allocation simulation unit 301 compared with the resource allocation apparatus 1 according to Embodiment 1.

In FIG. 13, similar components as shown in FIG. 1 are labeled with the same reference symbols, and repeated description is omitted.

The resource allocation simulation unit 301 calculates the total amount of processing for each combination of a processor core allocation pattern and the first resource allocation pattern. The first resource allocation pattern is a pattern in which the first resource is allocated to the programs included in a congestion pattern. Also, a later-described second resource allocation pattern is a pattern in which the second resource is allocated to the programs included in a congestion pattern.

The processor core allocation unit 302 has a plurality of processor cores, and the first resource available in each of the processor cores, and determines the processor core allocation pattern indicating which processor core is used for executing a program to be executed on a system having the second resource shared by the processor cores. Specifically, the processor core allocation unit 302 determines the processor core allocation pattern using the total amount of processing calculated by the resource allocation simulation unit 301.

The first resource is level 1 cache and the second resource is level 2 cache herein.

The first resource allocation pattern determination unit 303 determines the first resource allocation pattern for each congestion pattern using the total amount of processing calculated by the resource allocation simulation unit 301.

The second resource allocation pattern determination unit 304 determines the second resource allocation pattern for each congestion pattern.

The resource allocation simulation unit 301, the processor core allocation unit 302, the first resource allocation pattern determination unit 303, and the second resource allocation pattern determination unit 304 are normally achieved by e.g., an MPU, and a memory. The functions of the resource allocation simulation unit 301, the processor core allocation unit 302, the first resource allocation pattern determination unit 303, and the second resource allocation pattern determination unit 304 are normally achieved by the MPU executing software (program). Also, the software is recorded on a recording medium (memory) such as a ROM. However, a part or all of the functions of the resource allocation simulation unit 301, the processor core allocation unit 302, the first resource allocation pattern determination unit 303, and the second resource allocation pattern determination unit 304 may be achieved by hardware (dedicated circuit).

Next, the operation of the resource allocation method performed by the resource allocation apparatus 3 is described.

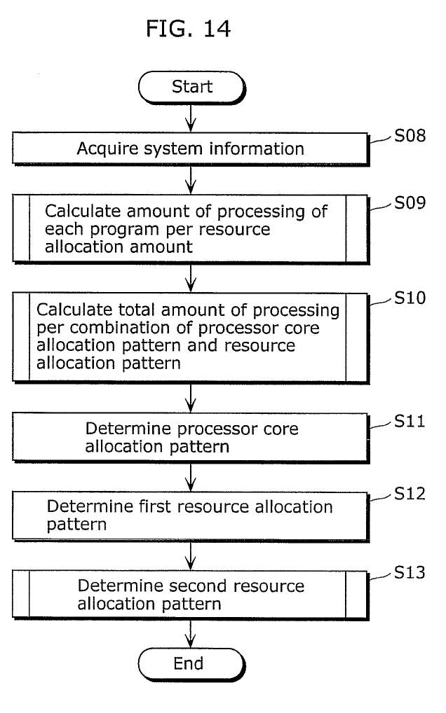

FIG. 14 is a flowchart showing the flow of the operation of the resource allocation method performed by the resource allocation apparatus 3. The process in steps S08 and S09 shown in FIG. 14 is similar to that in steps S01 and S02 shown in FIG. 2, thus detailed description is omitted.

### (Step S08)

In step S08, the system information acquisition unit 101 first acquires the system information inputted from the outside, which is to be used by the resource allocation method. The system information acquired by the system information acquisition unit 101 includes program information indicating a plurality of programs to be executed on a system; resource total amount information indicating the total amount of the first and second resources as a target to be allocated, which are mounted on the system; allocation unit information indicating the allocation unit of the first and second resources; and program congestion pattern information indicating a group of programs executed concurrently on the system.

### (Step S09)

In step S09, the processing amount calculation simulation unit 103 calculates the amount of processing of each program when different resource allocation amounts are allocated to respective programs.

### (Step S10)

In step S10, the resource allocation simulation unit 301 calculates the total amount of processing for each combination of the processor core allocation pattern and the first resource allocation pattern for each congestion pattern. Specifically, the resource allocation simulation unit 301 generates a plurality of first resource allocation patterns using the total amount of the first resource, and the allocation unit of the first resource, and calculates the total amount of processing of the generated first resource allocation patterns.

### (Step S11)

In step S11, the processor core allocation unit 302 determines which processor core is used for executing each program (allocation independent of the congestion pattern of program) using the total amount of processing calculated in step S10.

### (Step S12)

In step S12, the first resource allocation pattern determination unit 303 determines the optimal first resource allocation pattern using the total amount of processing calculated in step S10. Specifically, the first resource allocation pattern determination unit 303 determines the first resource allocation pattern with the least total amount of processing as the optimal first resource allocation pattern.

### (Step S13)

In step S13, the second resource allocation pattern determination unit 304 generates a plurality of second resource allocation patterns which allocate the second resource to the programs included in the congestion pattern using the total amount of the second resource, and the allocation unit of the second resource. Also, the second resource allocation pattern determination unit 304 calculates the total amount of processing for each second resource allocation pattern in the case where the processor core allocation pattern and the first resource allocation pattern determined in step S10 and step S11 are used. Furthermore, the second resource allocation pattern determination unit 304 determines the second resource allocation pattern with the least total amount of processing as the optimal second resource allocation pattern for each congestion pattern.

Next, detailed operation in step S10 is described.

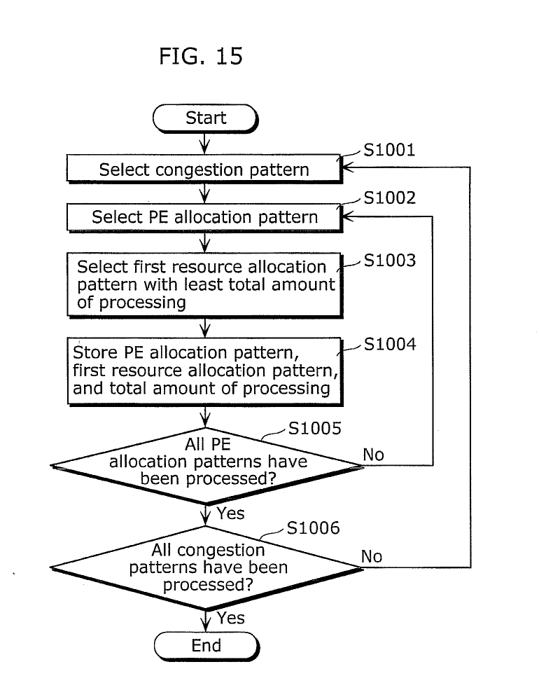

FIG. 15 is a flowchart showing the flow of the operation in step S10.

### (Step S1001)

In step S1001, the resource allocation simulation unit 301 selects one congestion pattern from a plurality of congestion patterns indicated in the program congestion pattern information acquired by the system information acquisition unit 101. Also, the process from step S1001 to a later-described step S1006 form a loop, and all the congestion patterns are sequentially selected in step S1001.

### (Step S1002)

In step S1002, the resource allocation simulation unit 301 generates a plurality of processor core allocation patterns which allocate the programs included in the congestion pattern selected in step S1001 to a plurality of processor cores. The resource allocation simulation unit 301 selects one processor core allocation pattern among the generated processor core allocation patterns. Also, the process from step S1002 to a later-described step S1005 form a loop, and all the processor core allocation patterns are sequentially selected in step S1002.

### (Step S1003)

In step S1003, the resource allocation simulation unit 301 generates a plurality of first resource allocation patterns which allocate the first resource included in each processor core to the program allocated to the processor core in the processor core allocation pattern selected in step S1002. Also, the resource allocation simulation unit 301 calculates the total amount of processing of the programs in the generated first resource allocation patterns. The resource allocation simulation unit 301 selects the first resource allocation pattern with the least total amount of processing.

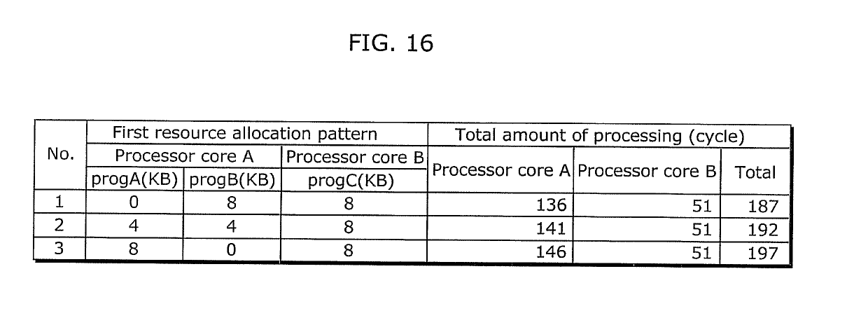

FIG. 16 is an exemplary table showing the total amount of processing of the programs for the first resource allocation patterns calculated in step S1003. FIG. 16 is an example in the case where the processor core allocation pattern in which prog A and prog B are allocated to the processor core A, and prog C is allocated to the processor core B is selected in step S1002. It is assumed that the total amount of the first resource included in the processor core A and the processor core B is 8 KB each, and its allocation unit is 4 KB.

As shown in FIG. 16, in step S1003, the resource allocation simulation unit 301 generates 3 first resource allocation patterns (No.1 to No.3) which allocate the first resource of the processor core A to prog A and the prog B allocated to the processor core A, and allocate the resource of the processor core B to prog C allocated to the processor core B. Also, the resource allocation simulation unit 301 selects the No.1 first resource allocation pattern with the least total amount of processing.

### (Step S1004)

In step S1004, the resource allocation simulation unit 301 associates the first resource allocation pattern selected in step S1003 with the processor core allocation pattern and the total amount of processing, then records the patterns and the total amount of processing in the information storage unit 105.

### (Step S1005)

In step S1005, the resource allocation simulation unit 301 determines whether or not all the processor core allocation patterns generated in step S1002 have been already selected. In the case where there exists an unselected processor core allocation pattern, the resource allocation simulation unit 301 selects a new processor core allocation pattern in step S1002, and performs step S1003 and the subsequent process for the newly selected processor core allocation pattern. Also, in the case where all the processor core allocation patterns have been selected, the resource allocation simulation unit 301 then performs step S1006.

### (Step S1006)

In step S1006, the resource allocation simulation unit 301 determines whether or not all the congestion patterns have been already selected in step S1001. In the case where there exists an congestion pattern, the resource allocation simulation unit 301 selects a new congestion pattern in step S1001, and performs step S1002 and the subsequent process for the newly selected congestion pattern. Also, in the case where all the congestion patterns have been selected, the resource allocation simulation unit 301 terminates the process in step S10.

By the above operation, for each of the entire processor core allocation patterns in all the congestion patterns, the first resource allocation pattern with the least total amount of processing is selected, and the information of the selected first resource allocation pattern is stored in the information storage unit 105.

Also, in step S11, the processor core allocation unit 302 determines the optimal processor core allocation pattern using the total amount of processing calculated in step S10. Specifically, the processor core allocation unit 302 determines the processor core allocation pattern by performing the similar process as in steps S0701 and S0702 described above. Alternatively, the processor core allocation unit 302 may determine any one of the processor core allocation patterns with the least total amount of processing as the optimal processor core allocation pattern.

Also, in step S12, the first resource allocation pattern determination unit 303 determines the optimal first resource allocation pattern using the total amount of processing calculated in step S10. Specifically, the first resource allocation pattern determination unit 303 determines the first resource allocation pattern by performing the similar process as in step S0703 described above. Alternatively, the first resource allocation pattern determination unit 303 determines the first resource allocation pattern without the least total amount of processing as the optimal first resource allocation pattern.

Next, detailed operation in step S13 is described.

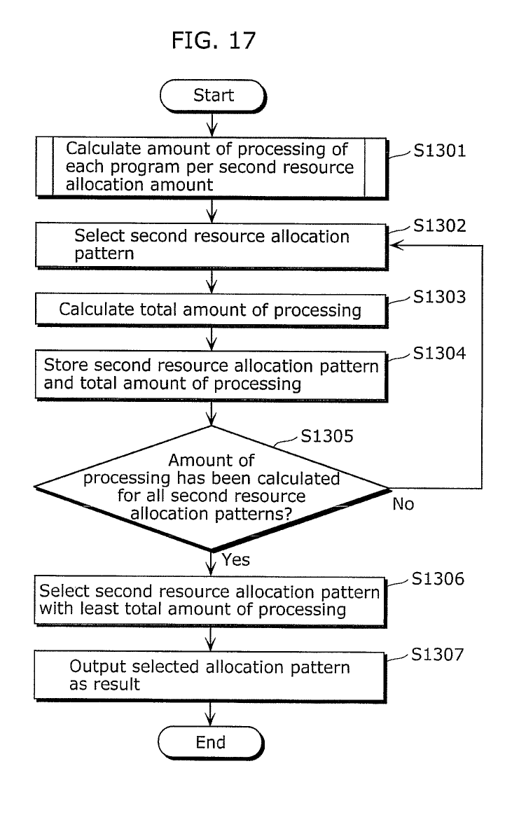

FIG. 17 is a flowchart showing the flow of step S13.

### (Step S1301)

In step S1301, the second resource allocation pattern determination unit 304 calculates the amount of processing of each program when different resource allocation amounts are allocated to respective programs. For example, detailed process in step S1301 is similar to the process with the resource being replaced by the second resource in step S02.

### (Step S1302)

In step S1302, the second resource allocation pattern determination unit 304 generates a plurality of second resource allocation patterns which allocate the second resource to a plurality of programs. The second resource allocation patterns generated by the second resource allocation pattern determination unit 304 are a plurality of patterns which allocate the second resource to all the programs included in a plurality of congestion patterns (prog A to prog E in the above-mentioned example). Next, the second resource allocation pattern determination unit 304 selects one of the generated second resource allocation patterns. Also, the process from step S1302 to a later-described step S1305 form a loop, and all the second resource allocation patterns are sequentially selected in step S1302.

### (Step S1303)

In step S1303, the second resource allocation pattern determination unit 304 calculates the total amount of processing of the programs in the second resource allocation pattern selected in step S1302.

### (Step S1304)

In step S1304, the second resource allocation pattern determination unit 304 associates the second resource allocation pattern selected in step S1302 with the total amount of processing calculated in step S1303, then records the pattern and the total amount of processing in the information storage unit 105.

### (Step S1305)

In step S1305, the second resource allocation pattern determination unit 304 determines whether or not all the second resource allocation patterns have been selected in step S1302. In the case where all the second resource allocation patterns have been selected, the second resource allocation pattern determination unit 304 next performs S1306 and the subsequent process, otherwise in the case where all the second resource allocation patterns have not been selected, the second resource allocation pattern determination unit 304 next selects a new second resource allocation pattern, and performs step S1303 and the subsequent process for the newly selected second resource allocation pattern.

### (Step S1306)

In step S1306, the second resource allocation pattern determination unit 304 selects the second resource allocation pattern with the least total amount of processing among the second resource allocation patterns recorded in the information storage unit 105.

### (Step S1307)

In step S1307, the second resource allocation pattern determination unit 304 outputs the second resource allocation pattern selected in step S1306 as an allocation result of the second resource.

The second resource allocation pattern determination unit 304 may perform steps S1301 to S1307 for each of the congestion patterns.

As described above, according to the resource allocation apparatus 3 and the resource allocation method by Embodiment 3 of the present invention, the optimal resource allocation which guarantees operational performance can be determined for a target system in which a plurality of programs are executed concurrently, the system having a plurality of processor cores and a plurality of stages of cache memory.

The resource allocation apparatus 1 to 3 according to Embodiments 1 to 3 of the present inventions may be achieved as software development apparatus for developing the software which is executed on the above-mentioned system. Also, the present invention may be achieved as a software development program for developing the software which operates on the system and causes a computer to execute the resource allocation method described above. The software development program may be distributed by e.g., software download. Alternatively, the program may be recorded on a recording medium such as a CD-ROM and distributed.

Also, the resource allocation apparatus 1 to 3 according to Embodiments 1 to 3 of the present inventions may be achieved as software controlling apparatus, which is included in the above-mentioned system, and is operated on the system. Alternatively, the present invention may be achieved as a software control program, which is operative in the above-mentioned system and causes a computer included in the system to execute the resource allocation method described above.

A part of the functions of the resource allocation apparatus 1 to 3 according to Embodiments 1 to 3 of the present invention may be achieved as the above-mentioned software development apparatus, and the rest of the functions may be achieved as the above-mentioned software controlling apparatus. Similarly, a part of the programs which cause a computer to execute the resource allocation method according to Embodiments 1 to 3 of the present inventions may be achieved as the above-mentioned software development program, and the rest of the functions may be achieved as the above-mentioned software control program. For example, the function of the processing amount calculation simulation unit 103 may be achieved as software development apparatus, and other processing units may be achieved as software controlling apparatus.

Also, the above-mentioned program does not necessarily include an operating system (OS), a third party program, and the like which cause a computer to execute the resource allocation apparatus of Embodiments 1 to 3 described above. The above-mentioned program may include only an instructional section, which calls an appropriate function (module) in a controlled state so as to obtain a desired result. How a computer system operates is well known, thus detailed description is omitted.

Also, processing performed by hardware in a transmission step for transmitting information, or a reception step for receiving information, for example, processing performed by a modem or an interface card (processing performed only by hardware) in a transmission step is not included in the above-mentioned program.

Also, the number of computers which execute the above-mentioned program may be a single or multiple. In other words, the computer may perform centralized processing, or may perform distributed processing.

In the above-mentioned Embodiments 1 to 3, each process (each function) may be achieved by a single apparatus (system) performing centralized processing, or by multiple apparatus performing distributed processing.

Alternatively, at least a part of the functions of the resource allocation apparatus 1 to 3 according to some of the above-mentioned Embodiments 1 to 3, and the resource allocation apparatus 1 to 3 according to the rest of Embodiments 1 to 3 may be combined.

The present invention is not limited to the above embodiments, thus may be modified in various manners, and it needless to say that the modified embodiments are within the scope of the present invention.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

As described above, the resource allocation apparatus and the resource allocation method according to the present invention have the effect that the optimal resource allocation pattern for a plurality of programs can be determined to make the system meet the required performance, thus the invention can be applied to software or hardware operating in a system, to which the resource allocation apparatus is installed. Also, the resource allocation apparatus and the resource allocation method according to the present invention can be applied to e.g., a program development tool.

What is claimed is:

1. A resource allocation method for determining a resource allocation pattern indicating allocation amounts of a resource to be allocated to a plurality of programs in a system in which the programs are executed with the resource divided between or shared by the programs, said method comprising:
acquiring a total amount of the resource, an allocation unit of the resource, and program congestion pattern information indicating a group of programs executed concurrently in the system; and
determining resource allocation by generating a plurality of resource allocation patterns for allocating the resource to programs included in the group of programs indicated in the program congestion pattern information, using the total amount of the resource and the allocation unit, calculating a total of amount of processing needed to execute the programs when the resource is allocated to the programs included in the group of programs by the generated resource allocation patterns, and determining an optimal resource allocation pattern among the generated resource allocation patterns, as a resource allocation pattern for the programs included in the group of programs, based on the calculated total amount of processing.

2. The resource allocation method according to claim 1,
wherein in said determining of resource allocation, a resource allocation pattern with least total amount of processing needed to execute the programs included in the group of programs among the generated resource allocation patterns is determined as a resource allocation pattern for the programs included in the group of programs.

3. The resource allocation method according to claim 2,
wherein said determining of resource allocation includes:
calculating amount of processing needed to execute the programs when the resource is allocated to respective programs included in the group of programs using a plurality of different resource allocation amounts; and
generating the resource allocation patterns using the total amount of the resource and the allocation unit, calculating a total amount of processing which is a total of amount of processing needed to execute the respective programs included in the group of programs in the resource allocation pattern by adding the amount of processing calculated in said calculating of amount of processing, the amount of processing corresponding to a combination of programs and the allocation amounts indicated by each resource allocation pattern of the generated resource allocation patterns, and determining a resource allocation pattern with least calculated total amount of processing as a resource allocation pattern for the programs included in the group of programs.

4. The resource allocation method according to claim 1,
wherein the programs can be allocated to one of a plurality of processor cores included in the system to be executed, and
said determining of resource allocation includes
allocating of processor core for determining a processor core allocation pattern which allocates each of the programs included in the group of programs to any of the processor cores using amount of processing needed to execute each program, the amount of processing when resource in an allocation amount indicated by the resource allocation pattern determined in said determining of resource allocation is allocated to the programs, so that total amount of processing needed to execute one or more programs allocated to each processor core of the processor cores is less than or equal to throughput of the processor core.

5. The resource allocation method according to claim 4,
wherein the program congestion pattern information indicates a plurality of groups of programs including the group of programs;
the groups of programs includes a same program;
in said determining of resource allocation, the resource allocation pattern is determined for each of the groups of programs; and
said allocating of processor core includes:
generating a plurality of processor core allocation patterns for allocating each of the programs included in the group of programs to the processor cores for each of the groups of programs;
extracting one or more processor core allocation patterns among processor core allocation patterns for the generated group of programs using amount of processing needed to execute each program, the amount of processing when resource in an allocation amount indicated by a resource allocation pattern corresponding to the group of programs is allocated to the programs, the resource allocation pattern being determined in said determining of resource allocation for each of the groups of programs, so that total amount of processing needed to execute a program allocated to each of the processor cores is less than or equal to throughput of the processor core; and
determining a processor core allocation pattern in which the same program is allocated to a same processor core among the extracted one or more processor core allocation patterns for each of the groups of programs, as a processor core allocation pattern for allocating the programs included in the groups of programs to any of the processor cores.

6. The resource allocation method according to claim 2,
wherein the resource corresponds to each of the processor cores, and includes a first resource which is used by the corresponding processor core, and a second resource which is shared by the processor cores;
in said acquiring, a total amount of the first resource, a total amount of the second resource, an allocation unit of the first resource, an allocation unit of the second resource, and the program congestion pattern information are acquired;
said determining of resource allocation includes:
determining a first resource allocation that generates a plurality of first resource allocation patterns for allocating the first resource to the programs included in the groups of programs using the total amount of the first resource and the allocation unit of the first resource, and determines the first resource allocation pattern with least total amount of processing needed to execute the programs included in the groups of programs among the generated first resource allocation patterns as the first resource allocation pattern for the programs included in the groups of programs; and
determining a second resource allocation that generates a plurality of second resource allocation patterns for allocating the second resource to the programs included in the groups of programs using the total amount of the second resource and the allocation unit of the second resource, and determines the second resource allocation pattern with least total amount of processing needed to execute the programs included in the groups of programs among the generated second resource allocation patterns as the second resource allocation pattern for the programs included in the groups of programs.

7. A non-transitory computer readable recording medium for recording a program of a resource allocation method for determining a resource allocation pattern indicating allocation amounts of resource to be allocated to a plurality of programs in a system in which the programs are executed with the resource divided between or shared by the programs,
wherein the program causes a computer to execute acquiring total amount of the resource, an allocation unit of the resource, and program congestion pattern information indicating a group of programs executed concurrently in the system; and
determining resource allocation for generating a plurality of resource allocation patterns for allocating the resource to the programs included in the group of programs indicated in the program congestion pattern information using the total amount of the resource and the allocation unit, calculating total of amount of processing needed to execute the programs when the resource is allocated to the programs included in the group of programs by the generated resource allocation patterns, and determining an optimal resource allocation pattern among the generated resource allocation patterns as a resource allocation pattern for the programs included in the group of programs based on the calculated total amount of processing.

8. The recording medium according to claim 7,
wherein in said determining of resource allocation, a resource allocation pattern with least total amount of processing needed to execute the programs included in the group of programs among the generated resource allocation patterns is determined as a resource allocation pattern for the programs included in the group of programs.

9. The recording medium according to claim 8,
wherein said determining of resource allocation includes:
calculating amount of processing needed to execute the programs when the resource is allocated to respective programs included in the group of programs using a plurality of different resource allocation amounts; and
generating the resource allocation patterns using the total amount of the resource and the allocation unit, calculating a total amount of processing which is a total of amount of processing needed to execute the respective programs included in the group of programs in the resource allocation pattern by adding the amount of processing calculated in said calculating of amount of processing, the amount of processing corresponding to a combination of programs and the allocation amounts indicated by each resource allocation pattern of the generated resource allocation patterns, and determining a resource allocation pattern with least calculated total amount of processing as a resource allocation pattern for the programs included in the group of programs.

10. The recording medium according to claim 7,
wherein the programs can be allocated to one of a plurality of processor cores included in the system to be executed, and
said determining of resource allocation includes
allocating of processor core for determining a processor core allocation pattern which allocates each of the programs included in the group of programs to any of the processor cores using amount of processing needed to execute each program, the amount of processing when resource in an allocation amount indicated by the resource allocation pattern determined in said determining of resource allocation is allocated to the programs, so that total amount of processing needed to execute one or more programs allocated to each processor core of the processor cores is less than or equal to throughput of the processor core.

11. The recording medium according to claim 10,
wherein the program congestion pattern information indicates a plurality of groups of programs including the group of programs;
the groups of programs includes a same program;
in said determining of resource allocation, the resource allocation pattern is determined for each of the groups of programs; and
said allocating of processor core includes:
generating a plurality of processor core allocation patterns for allocating each of the programs included in the group of programs to the processor cores for each of the groups of programs;
extracting one or more processor core allocation patterns among processor core allocation patterns for the generated group of programs using amount of processing needed to execute each program, the amount of processing when resource in an allocation amount indicated by a resource allocation pattern corresponding to the group of programs is allocated to the programs, the resource allocation pattern being determined in said determining of resource allocation for each of the groups of programs, so that total amount of processing needed to execute a program allocated to each of the processor cores is less than or equal to throughput of the processor core; and
determining a processor core allocation pattern in which the same program is allocated to a same processor core among the extracted one or more processor core allocation patterns for each of the groups of programs, as a processor core allocation pattern for allocating the programs included in the groups of programs to any of the processor cores.

12. The recording medium according to claim 8,
wherein the resource corresponds to each of the processor cores, and includes a first resource which is used by the corresponding processor core, and a second resource which is shared by the processor cores;
in said acquiring, a total amount of the first resource, a total amount of the second resource, an allocation unit of the first resource, an allocation unit of the second resource, and the program congestion pattern information are acquired;
said determining of resource allocation includes:
determining a first resource allocation that generates a plurality of first resource allocation patterns for allocating the first resource to the programs included in the groups of programs using the total amount of the first resource and the allocation unit of the first resource, and determines the first resource allocation pattern with least total amount of processing needed to execute the programs included in the groups of programs among the generated first resource allocation patterns as the first resource allocation pattern for the programs included in the groups of programs; and
determining a second resource allocation that generates a plurality of second resource allocation patterns for allocating the second resource to the programs included in the groups of programs using the total amount of the second resource and the allocation unit of the second resource, and determines the second resource allocation pattern with least total amount of processing needed to execute the programs included in the groups of programs among the generated second resource allocation patterns as the second resource allocation pattern for the programs included in the groups of programs.

13. A resource allocation apparatus which determines a resource allocation pattern indicating allocation amounts of resource to be allocated to a plurality of programs in a system in which the programs are executed with the resource divided between or shared by the programs, the resource allocation apparatus comprising:
an acquisition unit configured to acquire total amount of the resource, an allocation unit of the resource, and program congestion pattern information indicating a group of programs executed concurrently in the system; and
a resource allocation determination unit configured to generate a plurality of resource allocation patterns for allocating the resource to the programs included in the group of programs indicated in the program congestion pattern information using the total amount of the resource and the allocation unit, to calculate total of amount of processing needed to execute the programs when the resource is allocated to the programs included in the group of programs by the generated resource allocation patterns, and to determine an optimal resource allocation pattern among the generated resource allocation patterns as a resource allocation pattern for the programs included in the group of programs based on the calculated total amount of processing.

14. The resource allocation apparatus according to claim 13,
wherein said resource allocation determination unit is configured to determine a resource allocation pattern with least total amount of processing needed to execute the programs included in the group of programs among the generated resource allocation patterns as a resource allocation pattern for the programs included in the group of programs.

15. The resource allocation apparatus according to claim 14,
wherein said resource allocation determination unit includes:
a processing amount calculation unit configured to calculate an amount of processing needed to execute the programs when the resource is allocated to respective programs included in the group of programs using a plurality of different resource allocation amounts; and
a resource allocation unit configured to generate the resource allocation patterns using the total amount of the resource and the allocation unit, to calculate a total amount of processing which is a total of amount of processing needed to execute the respective programs included in the group of programs in the resource allocation pattern by adding the amount of processing calculated in said processing amount calculation unit, the amount of processing corresponding to a combination of programs and the allocation amounts indicated by each resource allocation pattern of the generated resource allocation patterns, and to determine a resource allocation pattern with least calculated total amount of processing as a resource allocation pattern for the programs included in the group of programs.

16. The resource allocation apparatus according to claim 13,
wherein the programs can be allocated to one of a plurality of processor cores included in the system to be executed, and
said resource allocation determination unit includes
a processor core allocation unit configured to determine a processor core allocation pattern which allocates each of the programs included in the group of programs to any of the processor cores using amount of processing needed to execute each program, the amount of processing when resource in an allocation amount indicated by the resource allocation pattern determined in said resource allocation determination unit is allocated to the programs, so that total amount of processing needed to execute one or more programs allocated to each processor core of the processor cores is less than or equal to throughput of the processor core.

17. The resource allocation apparatus according to claim 16,
wherein the program congestion pattern information indicates a plurality of groups of programs including the group of programs;
the groups of programs includes a same program;
said resource allocation determination unit is configured to determine the resource allocation pattern for each of the groups of programs; and
said processor core allocation unit is configured
to generate a plurality of processor core allocation patterns for allocating each of the programs included in the group of programs to the processor cores for each of the groups of programs,
to extract one or more processor core allocation patterns among processor core allocation patterns for the generated group of programs using amount of processing needed to execute each program, the amount of processing when resource in an allocation amount indicated by a resource allocation pattern corresponding to the group of programs is allocated to the programs, the resource allocation pattern being determined in said resource allocation determination unit for each of the groups of programs, so that total amount of processing needed to execute a program allocated to each of the processor cores is less than or equal to throughput of the processor core, and
to determine a processor core allocation pattern in which the same program is allocated to a same processor core among the extracted one or more processor core allocation patterns for each of the groups of programs, as a processor core allocation pattern for allocating the programs included in the groups of programs to any of the processor cores.

18. The resource allocation apparatus according to claim 14,
wherein the resource corresponds to each of the processor cores, and includes a first resource which is used by the corresponding processor core, and a second resource which is shared by the processor cores;
said acquisition unit is configured to acquire a total amount of the first resource, a total amount of the second resource, an allocation unit of the first resource, an allocation unit of the second resource, and the program congestion pattern information;
said resource allocation determination unit includes:
a first resource allocation pattern determination unit configured to generate a plurality of first resource allocation patterns for allocating the first resource to the programs included in the groups of programs using the total amount of the first resource and the allocation unit of the first resource, and to determine the first resource allocation pattern with least total amount of processing needed to execute the programs included in the groups of programs among the generated first resource allocation patterns as the first resource allocation pattern for the programs included in the groups of programs; and
a second resource allocation pattern determination unit configured to generate a plurality of second resource allocation patterns for allocating the second resource to the programs included in the groups of programs using the total amount of the second resource and the allocation unit of the second resource, and to determine the second resource allocation pattern with least total amount of processing needed to execute the programs included in the groups of programs among the generated second resource allocation patterns as the second resource allocation pattern for the programs included in the groups of programs.
